(19) United States
(12) Patent Application Publication
(10) Pub. No.: US 2002/0093582 A1
(43) Pub. Date: Jul. 18, 2002

(54) Data communication terminal and camera

(76) Inventors: Taizou Aoki, Itami-Shi (JP); Akira Fukuda, Osaka (JP); Masahito Niikawa, Osaka (JP)

Correspondence Address: MCDERMOTT, WILL & EMERY, 600 13th Street, N. W., Washington, DC, 20005-3096, US

(21) Appl. No.: 10/036,491

(22) Filed: Jan. 7, 2002

(30) Foreign Application Priority Data
Jan. 12, 2001 (JP) P2001-004896

(51) Int. Cl. H04N 5/222

(52) U.S. Cl. 348/333.02; 348/333.05; 348/231

(57) ABSTRACT

A digital camera functioning as a data communication terminal generates a “new file for transmission” which is a new file by copying data contents of an “original file for transmission” which is a file to be sent to a server, and transmits the new file for transmission to the server after giving a file name which is different from a file name of the original file for transmission to the new file for transmission. The file name after changing has a variable part having a number which increases in accordance with a number of times of send. For example, as for an original file for transmission “PIC00001.JPG”, the file name is changed to “00100001.JPG” in the first transmission and “00200001.JPG” in the second transmission. Therefore, the server recognizes these files as different files, so that it is possible to prevent the file from being overwritten by mistake.

This application is based on application No. 2001-4896 filed in Japan, the contents of which are hereby incorporated by reference.

### BACKGROUND OF THE INVENTION

1. Field of the invention

The present invention relates to an art for preventing a file from being overwritten by mistake in transmitting a file from a data communication terminal to a server.

2. Description of the Background Art

It has been conventionally known a system which manages in a server information being sent from a data communication terminal. In such a system, a plurality of files are sent from the data communication terminal to the server.

In transmission of files from the data communication terminal to the server in the above system, however, there might arises a case that if a file having the same name as that of a send file already exists in the server, the already-existing file is overwritten with the send file by mistake.

For example, as shown in FIGS. 29A to 29C, it is assumed that a data communication terminal 900 sends a file “PIC00001.JPG” to a server SV (FIG. 29A), where the file is modified in respect of data F1 which is data contents thereof by means of other appliances such as a client computer and saved in the same name (FIG. 29B), and the file of the same name “PIC00001.JPG” is resent to the server SV by means of the data communication terminal 900 (FIG. 29C). In this case, though the data contents of the data stored in the server SV has been modified to data F2 in FIG. 29B, if the file is send in the same name “PIC00001.JPG” at the time of resending the file (FIG. 29C), the file before modification will be overwritten with the file after modification.

Overwriting as described above often occurs against an operator's intention. For instance, it is assumed that a file which should not have been resent is sent as a result that the operator makes a mistake in selecting a file to be sent. There is a case that a file is overwritten as a result of such an erroneous sending. Also there is a problem that the original data which has been erased by being overwritten (F2 in the present case) is difficult to be restored.

### SUMMARY OF THE INVENTION

A first aspect of the present invention is directed to a data communication terminal which sends data to a server, comprising: a designating part for designating an original file having an original file name and data contents; a file name giving part for generating a new file obtained by copying the data contents of the original file and giving a new file name which is different from the original file name; and a sending part for sending the new file to the server, wherein the new file name has a characteristic part indicating that the new file is subjected to file-sending.

According to the first aspect, in transmitting a file from a data communication terminal to a server, it is possible to prevent a file from being overwritten by mistake even at the time of resending the file.

A second aspect of the present invention is directed to a data communication terminal in which the new file name has a common part common to the original file name.

According to the second aspect, correspondence between the file in the server and the file in the data communication terminal is readily recognized.

A third aspect of the present invention is directed to a data communication terminal in which the characteristic part has a number part updated for each file-sending operation.

According to the third aspect, files sent in different times of send can be distinguished from each other.

A fourth aspect of the present invention is directed to a data communication terminal which sends data to a server, comprising: a command issuing part for issuing a command to create a new folder in the server for each file-sending operation before sending a data file to the server; and a sending part for sending the data file into the new folder created in the server in accordance with the command.

According to the fourth aspect, it is possible to prevent a file in the server from being overwritten by mistake.

A fifth aspect of the present invention is directed to a camera capable of sending data to a server, comprising: a designating part for designating a data file; an acquiring part for acquiring a file list representative of files stored in a predetermined folder of the server; a determination part for determining, with respect to files of file names having a predetermined identifier among files included in the file list, whether or not a preceding file having the same name as that of the data file exists; and a warning part for giving a warning when the preceding file is found in the file list.

According to the fifth aspect, it is possible to prevent a file in the server from being overwritten by an operator's mistake.

A sixth aspect is directed to a camera capable of sending data to a server, comprising: a designating part for designating a data file; an acquiring part for acquiring a file list representative of files stored in a predetermined folder of the server; a determination part for determining, with respect to files of file names having a predetermined identifier among files included in the file list, whether or not a preceding file having the same name as that of the data file exists; and a sending piart for sending the data file to the server after renaming the data file when the preceding file is found in the file list.

According to the sixth aspect, it is possible to prevent a file in the server from being overwritten by an operator's mistake.

The present invention is also directed to a computer software product including a computer-readable recording medium in which software programs are recorded, the software programs being installed to a microcomputer built into a data communication terminal such as camera to realize the individual functions as described above.

Therefore, it is an object of the present invention to provide an art which prevents a file from being overwritten by mistake when transmitting a file from a data communication terminal to a server.

These and other objects, features, aspects and advantages of the present invention will become more apparent from the following detailed description of the present invention when taken in conjunction with the accompanying drawings.

### BRIEF DESCRIPTION OF THE DRAWING

FIG. 1 is a top view showing an essential configuration of a digital camera according to the first preferred embodiment of the present invention;

FIG. 2 is a rear view showing the essential configuration of the digital camera;

FIG. 3 is a functional block diagram of the digital camera;

FIG. 4 is a flowchart showing a flow of communication operations in the digital camera;

FIGS. 5A and 5B are views showing an operation for selecting an image;

FIG. 6 is a view showing a display state of LCD at the time of “SEND IMAGE”;

FIG. 7 is a view showing a setting screen of “ACCESS POINT”;

FIG. 8 is view showing a confirmation screen of transmission settings;

FIG. 9 is a view showing a display state of LCD at the time of “SEND IMAGE”;

FIG. 10 is a view showing a display state of LCD at the time of “SEND IMAGE”;

FIG. 11 is a view showing a display state of LCD at the time of “SEND IMAGE”;

FIG. 12 is a view showing a display state of LCD at the time of “SEND IMAGE”;

FIG. 13 is a view showing a display state of LCD at the time of “SEND IMAGE”;

FIG. 14 is a view showing a display state of LCD at the time of “SEND IMAGE”;

FIGS. 15A, 15B and 15C are views showing the general outline in an image sending operation;

FIG. 16 is a view for explaining change of file name at the time of file sending;

FIG. 17 is a view showing an example of changing file names in the case of sending a plurality of files;

FIG. 18 is a flowchart showing a procedure of data sending in the second preferred embodiment;

FIG. 19 is a view showing a folder tree of a transmission destination server;

FIG. 20 is a flowchart showing a procedure of data sending in the third preferred embodiment;

FIG. 21 is a view showing one example of acquired file list information;

FIG. 22 is a view showing a confirmation screen with regard to overwriting of file name;

FIG. 23 is a flowchart showing a procedure of data sending in the fourth preferred embodiment;

FIG. 24 is a view showing one example of a rule with regard to changing of file name;

FIG. 25 is a view showing a folder tree in the server after sending operation according to a modified example;

FIG. 26 is a view showing a mobile phone functioning as a data communication terminal according to an modified example;

FIG. 27 is a functional block diagram of a mobile phone according to an modified example;

FIG. 28 is a view showing contents of a file named “PDAABCDE.ADR”; and

FIGS. 29A, 29B and 29C are views showing a file sending operation according to the prior art.

### DESCRIPTION OF THE PREFERRED EMBODIMENTS

In the following, preferred embodiments of the present invention will be explained in detail with reference to the drawings.

<A. First Preferred Embodiment>

<Essential Configuration of Digital Camera>

In the first preferred embodiment, the explanation will be made on the case where the present invention is applied to a digital camera functioning as a data communication terminal.

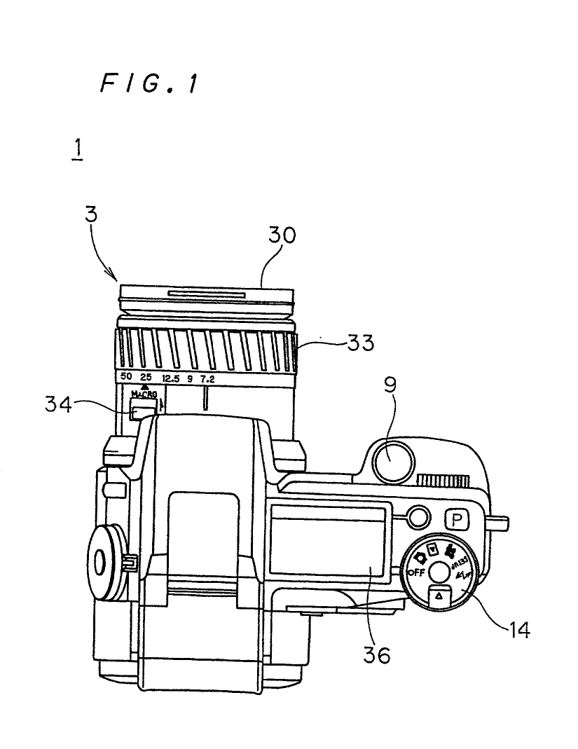

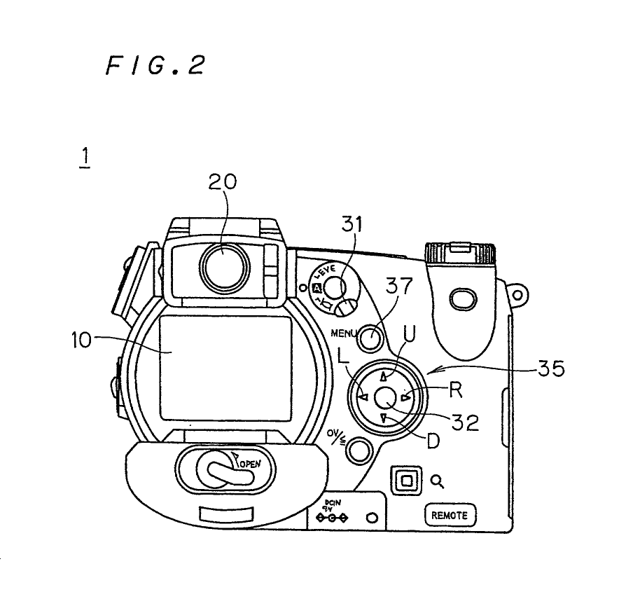

FIGS. 1 and 2 are views showing an essential configuration of a digital camera 1 according to the present preferred embodiment of the invention, wherein FIG. 1 corresponds to a top view and FIG. 2 corresponds to a rear view. These drawings are not always drawn in accordance with the triangular projection, but the main purpose of these drawings is to schematically exemplify the essential configuration of the digital camera 1.

As shown in FIG. 1, the digital camera 1 has a photographing section 3 which includes a photographing lens (hereinafter, simply referred to as “lens”) 30. The digital camera 1 also has a zoom function and can change the photographing magnification, for example, by rotating a zoom ring 33. Furthermore, the digital camera 1 has a macro changeover switch 34 which enables switching between macro photographing and normal photographing. Furthermore, on the top surface of the digital camera 1 is provided a shutter button 9.

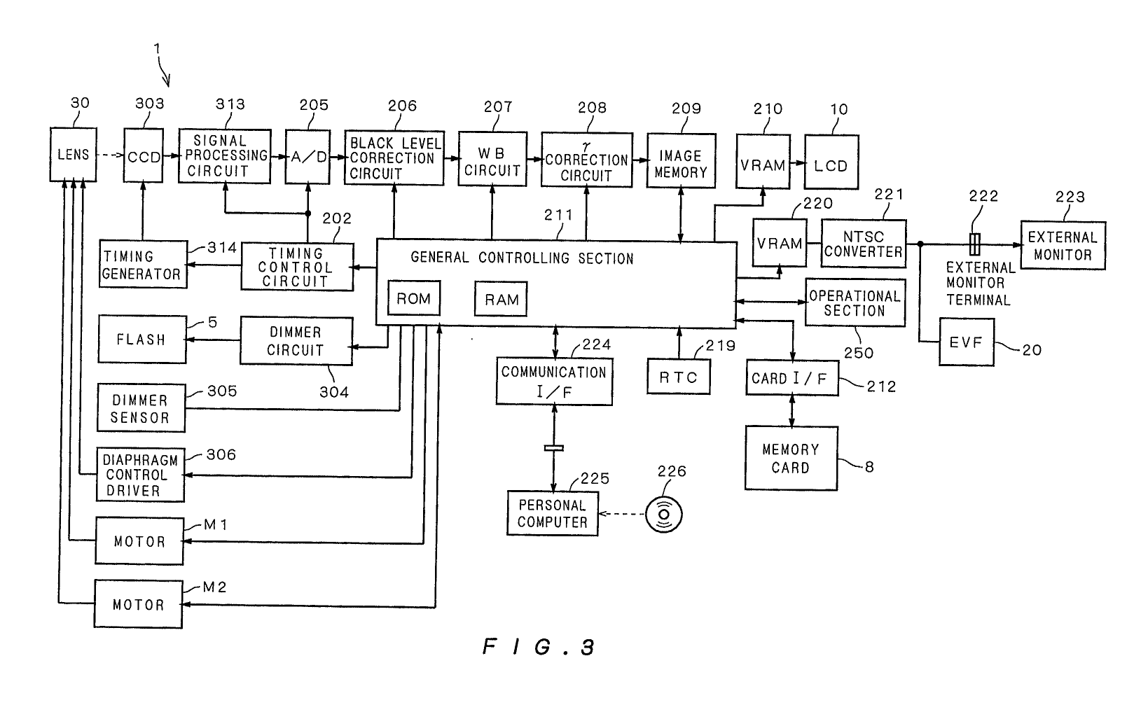

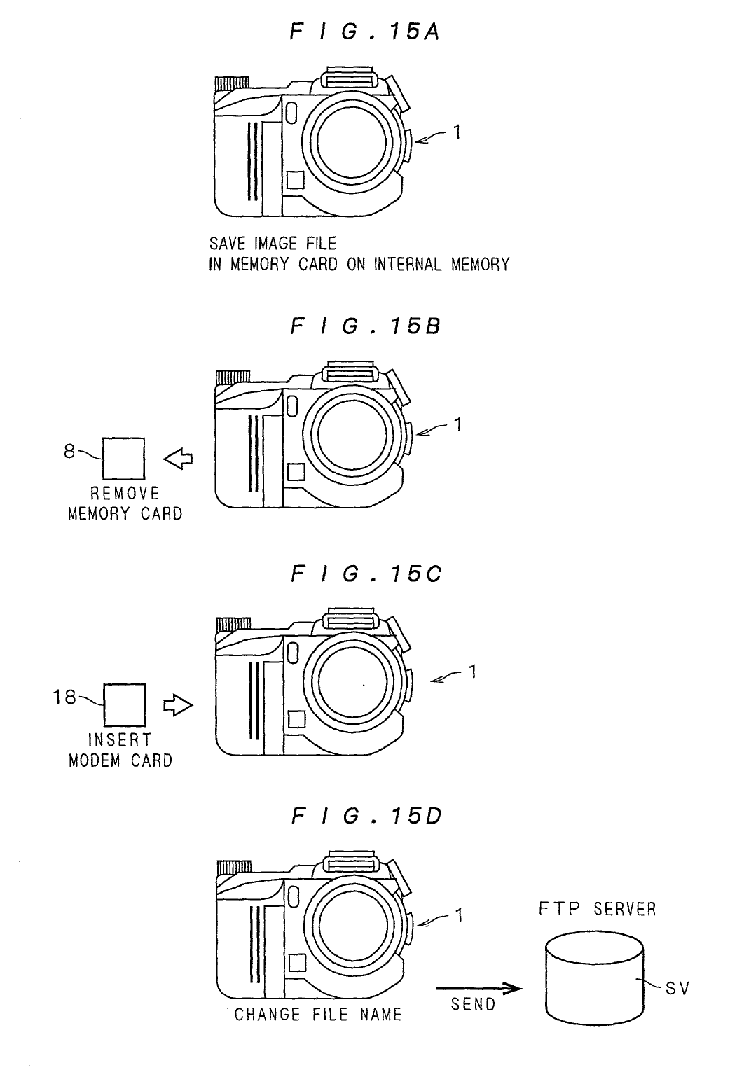

Also on the top surface of the digital camera 1 is provided a mode setting switch 14 for switching among “photographing mode”, “reproducing mode” and “connecting mode (communication mode)” to set the mode. The “photographing mode” is a mode for performing photographing, and the “reproducing mode” is a mode for reproducing a photographed image recorded on a memory card 8 (FIG. 3) to display it on an LCD 10. And the “connecting mode” is a mode for transmitting a photographed image to an FTP (file transfer protocol) server SV (See FIG. 15D) and the like over a communication line. Also on the top surface of the digital camera 1 is provided a body display section 36 on which setting conditions of the various modes are displayed.

As shown in FIG. 2, on the left of the rear surface of the digital camera 1 are provided a liquid crystal display (LCD) section 10 and an electronic viewfinder (EVG) 20 for achieving live display of photographed image and reproduction display of recorded image and the like. These LCD 10 and EVF 20 provide color displays.

On the right of the rear surface of the digital camera 1 is provided a control button 35 including cursor buttons U, D, L, R and an execution button 32, and various operations are made using this control button 35. Furthermore, on the rear surface of the digital camera 1 is provided a menu button 37. The menu button 37 is pressed down, and a variety of menus are displayed on the LCD 10. Also on the rear surface of the digital camera 1 is provided a display switching lever 31. This display switching lever 31 performs switching between LCD display and EVF display and the like.

<Functional Block of Digital Camera>

FIG. 3 is a functional block diagram of the digital camera 1. In FIG. 3, a CCD 303 photo-electrically converts an optical image of a subject focused by the lens 30 into an image signal (a signal composed of a signal string received by each pixel) of color components R(red), G(green) and B(blue) and outputs the signal. A timing generator 314 generates various kinds of timing pulses for controlling drive of the CCD 303.

Controlling of exposure in the photographing section 3 is achieved by adjusting a diaphragm of the lens 30 by means of a diaphragm control driver 306 and an exposure amount of the CCD 303, that is, an electric charge accumulation time of the CCD 330 corresponding to a shutter speed. In the case where it is impossible to set the shutter speed properly when the subject brightness is low, improper exposure due to a deficiency of exposure is corrected by adjusting the level of the image signal outputted from the CCD 303. That is, at the time of low brightness, exposure control is achieved by combination of shutter speed and gain adjustment. Level adjustment of an image signal is achieved by gain adjustment of an AGC circuit in a signal processing circuit 313.

The timing generator 314 generates a drive controlling signal of the CCD 303 based on a reference clock transmitted from a timing control circuit 202. The timing generator 314 generates clock signals such as a timing signal of start/end of integration (start/end of exposure) and a read controlling signal of light reception signal of each pixel (such as horizontal synchronous signal, vertical synchronous signal and transfer synchronous signal), for example, and outputs these signals to the CCD 303.

The signal processing circuit 313 performs a predetermined analogue signal processing on an image signal (an analogue signal) outputted from the CCD 303. The signal processing circuit 313 has a CDS (correlative double sampling) circuit and an AGC (auto gain control) circuit, and performs reduction of noise of an image signal by means of the CDS circuit, while performing level adjustment of the image signal by adjusting the gain of the AGC circuit.

A flash light control circuit 304 controls an amount of light emission of an built-in flash 5 at the time of flash photographing to a predetermined amount of light emission determined by a general controlling section 211. In flash photographing, reflected light of flash light from a subject is received by a sensor 305 at the same time the exposure starts, and when the amount of received light reaches a predetermined amount, a light emission stopping signal is outputted from the control circuit 304 and light emission of the built-in flash 5 is forcefully stopped in response to the light emission stopping signal, whereby the amount of light emission of the built-in flash 5 is controlled.

An A/D converter 205 converts each pixel signal of an image signal into a 12-bit digital signal. The A/D converter 205 converts each pixel (analogue signal) into a 12-bit digital signal in accordance with a clock for A/D conversion inputted from the timing generating circuit.

The timing control circuit 202 for generating clocks for the timing generator 314 and the A/D converter 205 is provided. The timing control circuit 202 is controlled by a reference clock within the general controlling section 211.

A black level correction circuit 206 corrects a black level of a pixel signal having subjected A/D conversion into a reference black level. On the other hand, a WB (white balance) circuit 207 performs level conversion of pixel data of each of the color components R, G, B. Using a level conversion table inputted from the general controlling section 211, the WB circuit 207 converts levels of image data of each of the color components R, G, B. Parameters (inclinations of characteristics) of each color component in the level conversion table are automatically or manually set for each photographed image by the general controlling section 211.

A γ correction circuit 208 corrects a gray scale of pixel data. An image memory 209 is a memory for storing pixel data outputted from the γ correction circuit 208. The image memory 209 has a memory capacity of at least one frame. That is, the image memory 209 has at least a memory capacity of image data of 1600×1200 pixels corresponding to the number of pixels of the CCD 303, wherein each pixel data is stored in its corresponding pixel position.

An LCD VRAM 210 is a buffer memory of image data displayed on the LCD 10. The LCD VRAM 210 has a memory capacity of image data corresponding to the number of pixels of the LCD 10, 400×300.

An EVF VRAM 220 is a buffer memory of image data displayed on the EVF 20. The EVR VRAM 220 has a memory capacity of image data corresponding to the number of pixels of the EVF 20, 640×480.

Furthermore, in a photographing standby state, each pixel data of images photographed every 1/30 (second) by the photographing section 3 is temporarily stored in the image memory 209 after being subjected to a predetermined signal processing by the A/D converter 205 to the γ correction circuit 208 , while being transferred to the LCD VRAM 210 and the EVF VRAM 220 via the general controlling section 211 to be displayed on the LCD 10 and the EVF 20 (live view display).

As a result of this, the user can view the image of the subject. On the other hand, in a reproducing mode, an image read out from the memory card 8 is transferred to the VRAM 210 after being subjected to a predetermined signal processing at the general controlling section 211, and then reproduced and displayed on the LCD 10. Also the same display is provided on the EVF 20.

A card I/F 212 is an interface for performing writing of image data and reading of image data to/from the memory card 8. The memory card 8 is mounted by being inserted into a memory slot (not shown) provided in the side surface of the digital camera 1. Into this memory slot, a modem card 18 (FIG. 15C) may be inserted in place of the memory card 8. In such a case, the card I/F 212 also functions as an interface which performs communication operation using the modem card 18 thus inserted into the memory slot.

Furthermore, a communication I/F 224 is an interface based on, for example, the USB standard for connecting a personal computer 225 to the external so as to allow communication therebetween. Via these card I/F 212 and the communication I/F 224, it is possible to take control programs recorded on recording media such as memory card 8 and CD-ROM 226 into a ROM of the general controlling section 211.

An RTC 219 is a clock circuit for managing a date and a time of photographing. The RTC 219 is driven by another power supply (not shown).

An operational section 250 consists of a variety of buttons such as the shutter button 9, display switching lever 31 and control button 35 as described above, a lever, etc.

The shutter button 9 is implemented by a two-step switch capable of detecting a half-pressed state (this state is also referred to as “S1 state”) and a fully-pressed state (this state is also referred to as “S2 state”) as is employed in conventional cameras with silver halide films. When the shutter button 9 is brought into the S1 state under the standby state, lens driving for automatic focusing (AF) is started, and the lens is driven and stopped by motors M1 and M2 so that the contrast becomes much higher while estimating the contrast of an image in the image memory 209 by the general controlling section 211. By determining the level of the image data in the image memory in the S1 state, a shutter speed and an aperture value are determined. In addition, a correction value of white balance is determined.

An NTSC converter 221 converts an image signal stored in the VRAM 220 into a signal of the NTSC system and transfers the resultant signal to the EVF 20 and an external monitor 223 via an external monitor terminal 222.

The general controlling section 211 is implemented by a microcomputer, and organically controls driving of each part of the above-mentioned camera to achieve centralized control of a photographing operation of the digital camera 1.

<Communication Operation in Digital Camera>

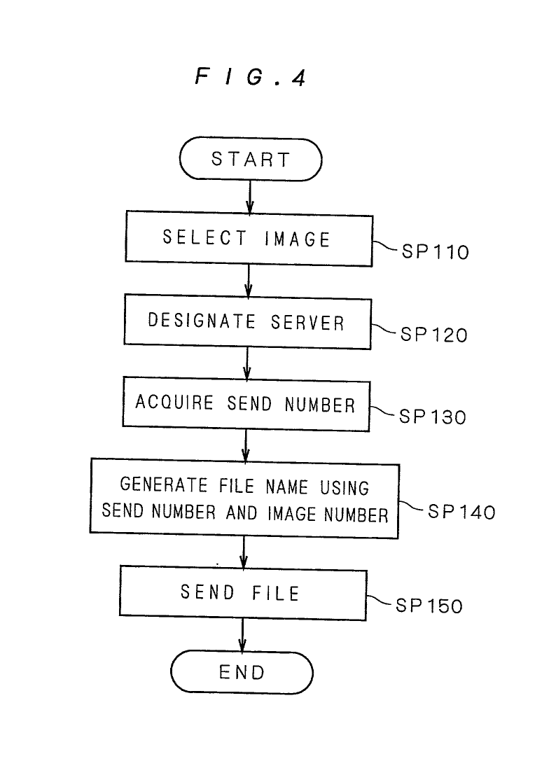

FIG. 4 is a flowchart showing a flow of communication operation in the digital camera 1. In the following, the communication operation will be explained with reference to FIG. 4 and the like.

Prior to the communication operation, the mode is switched to ×connecting mode” by the use of the mode setting switch 14 (FIG. 1). Then, using a menu screen (not shown) displayed on the LCD 10 (FIG. 2), an instruction for performing “Sending” operation is made.

Thereafter in step SP110, an image to be sent to the server is selected, and a file to be sent to the server is designated. For distinguishing from a “new file for transmission” as will be described later, a file stored in a memory card 8 in the designated file to be sent is referred to as “original file for transmission”.

FIGS. 5A and 5B are views showing an operation for selecting an image. FIG. 5A is a view showing display contents of the LCD 10 in the condition that the mode is set at the connecting mode (communication mode) by using the mode setting switch 14 and an instruction for performing sending operation has been made. In FIG. 5A, the condition that a send menu is displayed and a cursor CS is pointed at the column of “DESIGNATE FRAME TO BE SENT” in the send menu is shown. In this condition, it is possible to select executing the “DESIGNATE FRAME TO BE SENT” by pressing the execution button 32, moving the cursor CS to the left of the next column “SEND IMAGE” by pressing the cursor button D, or returning the previous screen by pressing the menu button 37.

In this situation, if the execution button 32 is pressed down, the display contents of the LCD 10 transits to the condition as shown in FIG. 5B. In the index screen shown in FIG. 5B, it is possible to designate which photographed image is to be selected among a plurality of photographed images (frames). To be more specific, it is possible to move the cursor CU for selection of photographed image (shown by the bold frame in the drawing) in the up-and-down direction and right and left direction with the use of the control button 35 including the cursor buttons U, D, L, R and the execution button 32. Then, by pressing down the execution button 32 with the cursor CU pointing at the image to be selected as an object to be sent, the photographed image is selected as an image to be sent. The selected image is checked by a checkmark for clearly show that the image is selected. After selecting a desired file, the operator presses down the menu button 37 to return to the screen as shown in FIG. 5A.

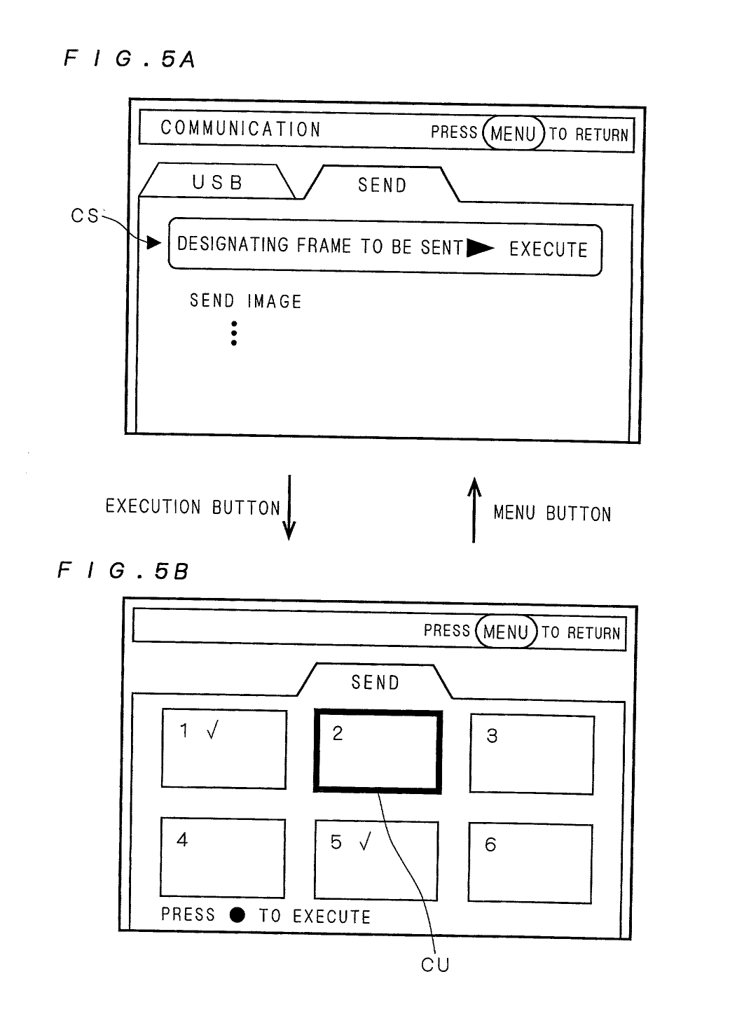

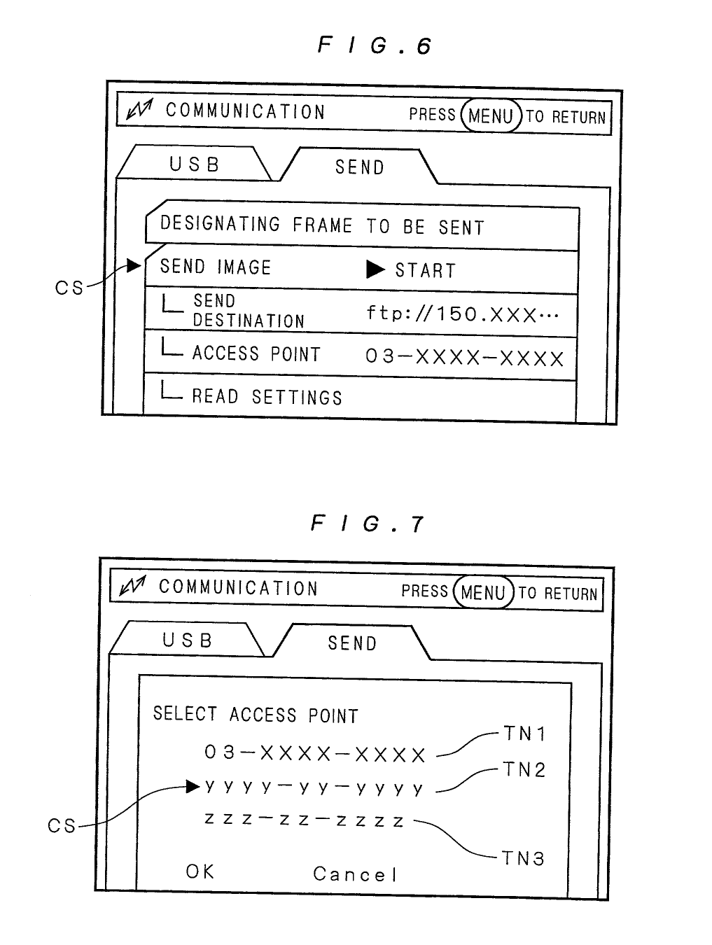

Then the cursor button D is pressed to cause the cursor CS to move on the left of the next column “SEND IMAGE”, and the screen condition of the LCD 10 turns to the condition as shown in FIG. 6.

In this case, below the column “SEND IMAGE”, the columns “SEND DESTINATION”, “ACCESS POINT” and the like are provided, and by moving the cursor CS on the left side of these columns using the cursor buttons U, D, it is possible to register or change the settings regarding send destination and access point.

For instance, for setting the “ACCESS POINT”, the screen as shown in FIG. 7 is used. As shown in FIG. 7, a list of telephone numbers TN1 to TN3 of destinations to be connected which have been set in advance is displayed. The operator moves the cursor CS within this screen using the cursor buttons U, D so that the cursor CS points at a desired telephone number to be connected, and thereafter presses the execution button 32. The general controlling section 211 of the digital camera 1 (FIG. 3) detects the pressing of the execution button 32, and the selected telephone number is set for the destination to be connected. In this way, setting of “SEND DESTINATION” can be achieved. Other settings of “SEND DESTINATION” and the like can be achieved in a similar procedure as described above.

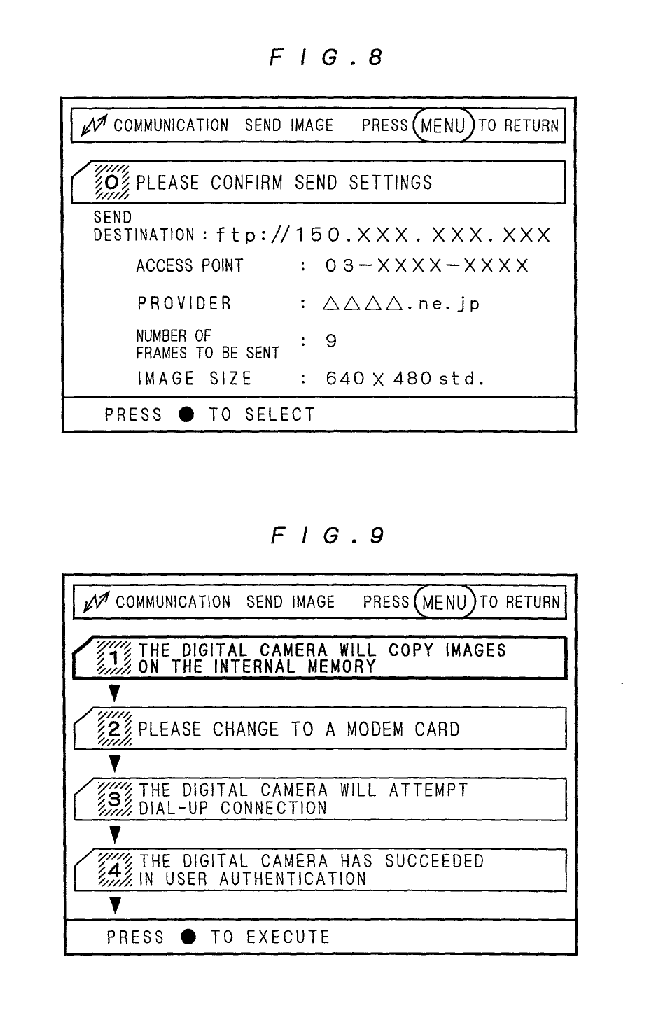

Then after completing a variety of settings and registrations as is necessary, the execution button 32 is pressed with the arrow being pointed at the left side of the column “SEND IMAGE”, and the display condition of the LCD 10 transits to the condition in which a confirmation screen of transmission settings is displayed (FIG. 8).

FIG. 8 is a view showing a confirmation screen of send settings. In this screen, a variety of settings (“SEND DESTINATION”, “ACCESS POINT”, “PROVIDER”, “NUMBER OF SEND FRAMES” AND “IMAGE SIZE”) set in the foregoing operations are displayed on the LCD 10.

In this drawing the case where the destination is set at a FTP server address of ftp://150.xxx.xxx.xxx and the access point is set at “03-xxxx-xxxx” is exemplified. Also in this drawing, the provider is “ΔΔΔΔ.ne.jp”, the number of send frames is 9, the image size is a standard size of 640×480.

The operator confirms the above setting contents displayed on the LCD 10. When it is necessary to change the settings, the operator presses the menu button 37 to return to the previous screen (FIG. 8), and conducts changing operation of settings. On the contrary, if it is not necessary to change the settings, that is, the displayed contents are desired contents, the operator presses the execution button 32 so as to execute the operation of “SEND IMAGE”. In this state, the designating operation of server in step SP120 (FIG. 4) completes.

FIGS. 9 to 14 show screens which are sequentially displayed on the LCD 10 during execution of the operation of “SEND IMAGE”. FIGS. 15A to 15D are views showing a general outline in the image sending operation. In this description, the explanation will be made for the case where in transmitting an image stored in the memory card 8 to the server SV, an operation of changing the memory card 8 and the modem card 18 in the card slot (not shown) provided on the side surface of the digital camera 1, as shown in FIGS. 15A to 15D.

To be more specific, first as shown in FIG. 9, an operation of copying an image into an internal memory is conducted. In this condition, the memory card 8 is attached in the memory slot, and image data stored in this memory card 8 is copied to the image memory 209 of the digital camera 1 (FIG. 15A). That is, by copying data contents (for example, image data) of an “original file for transmission” in the memory card 8 to the image memory 209, a “new file for transmission” is newly generated. It is to be noted that as will be described later, this “new file for transmission” will be given by a file name which is different from that of the original file for transmission.

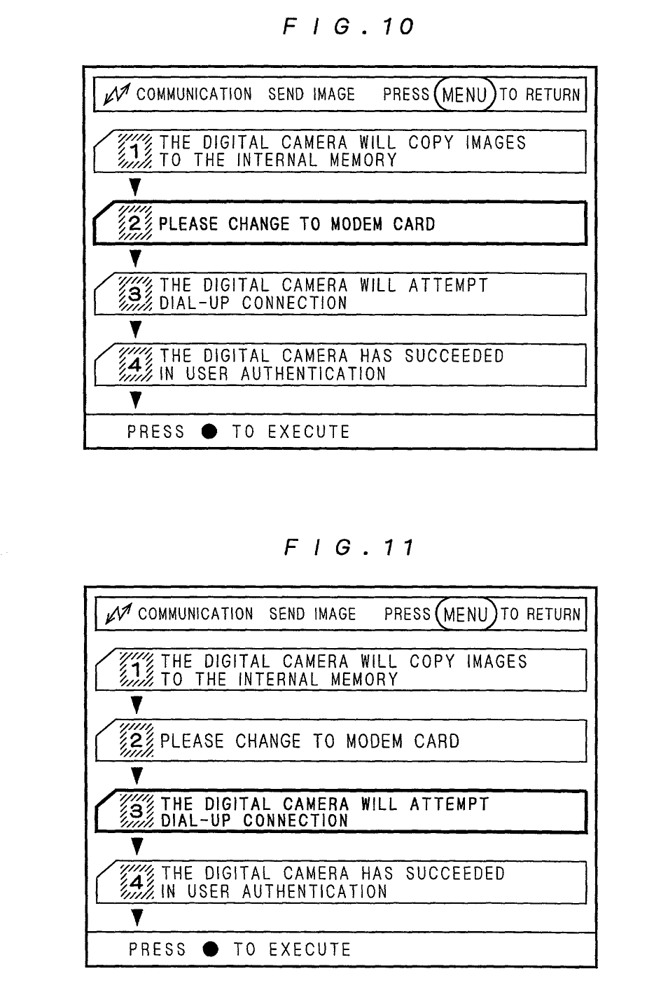

Upon completion of this coping operation, a next screen (FIG. 10) is displayed on the LCD 10 which requests the operator to change to a modem card. In response to this, the operator removes the memory card 8 from the memory slot (FIG. 15B) and inserts the modem card 18 into the memory slot alternatively (FIG. 15C).

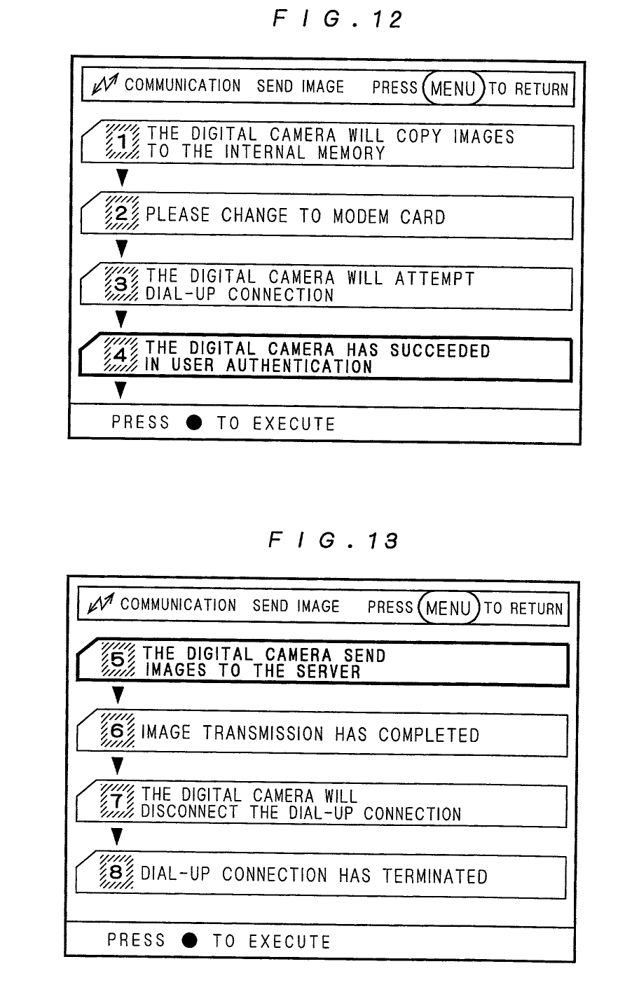

Upon detecting that the modem card has been mounted, the digital camera 1 automatically starts dialup connection (FIG. 11). The dialup connection is made with respect to the telephone number (access point) set in the above-described setting operation. After performing user authentication with respect to this dialup connection, the provider comes into the condition that permits user's access. FIG. 12 shows a view showing the screen which indicating that the digital camera 1 has succeeded in the user authentication, and that the connecting state to the network (Internet) has established by the dialup connection.

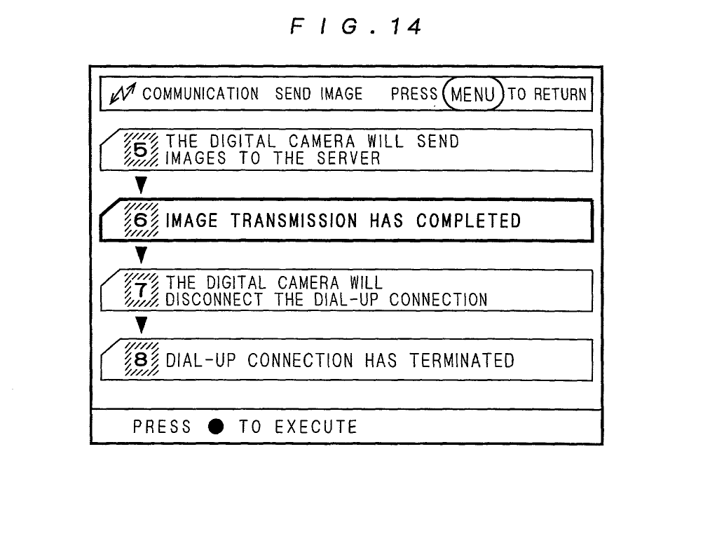

Next, as shown in FIG. 13, an image sending operation with respect to the server is performed (see also FIG. 15D). The destination is the FTP server which has been set in the above-described setting operation.

It is to be noted that prior to this image sending operation, the file name of the image file to be sent is changed in the manner as will be described later. In other words, a file having a file name which different from the original file name (that is “new file for transmission”) is sent to the server. At this time, as shown in FIG. 4, a “send number” is acquired in step SP130, and a file name of the new file for transmission is generated using the send number and the image number. “Send number” is a number indicating the times of sending operation from that digital camera 1 of the sending operation now being executed. After that, in step SP150, sending of image file through the network is executed.

Upon completion of the image sending operation, a display indicative of that is displayed on the LCD 10 (FIG. 14) and the dialup connection is disconnected. Finally, the message saying that the dialup connection has ended is displayed on the LCD 10, and the series of sending operations complete.

A single sending operation is executed in the manner as described above. It is to be noted that for conducting a sending operation again, the series of operations as described above may be repeated.

<As for Changing of File Name>

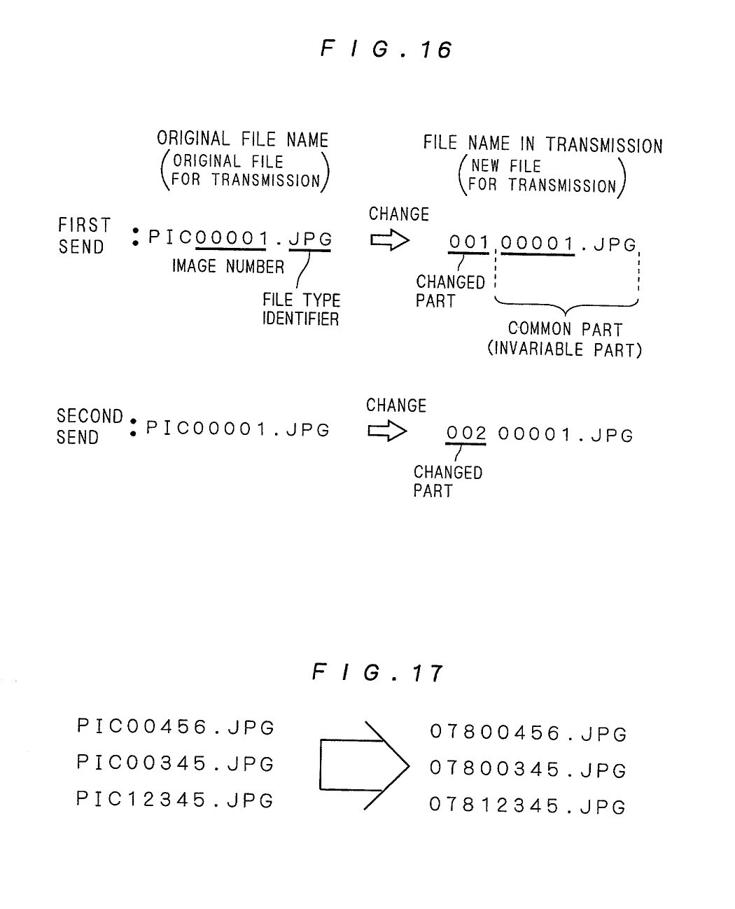

FIG. 16 is a view for explaining changing (rename) of file name at the time of file sending. In this context, the name of file designated as a file to be sent to the server (that is “original file for transmission”) is imparted as the name (“PIC00001.JPG”) which is created by combining first three characters “PIC” indicating that it is an image photographed by the digital camera 1, a subsequent 5-digit image number (in this context “00001” which is incremented every time an image is photographed) and an identifier indicating the file type “JPG” following a period.

And the file name of a new file for transmission is different from that of the original file for transmission in that the first three characters “PIC” are replaced by a 3-digit number indicating a send number (or number of sending). For example, in contrast to the original file for transmission “PIC00001.JPG”, the file name of a new file for transmission in the first send is “00100001.JPG”. Likewise, in contrast to the original file for transmission “PIC00001.JPG”, the file name of a new file for transmission in the second send is “00200001.JPG”. As described above, a file name of a new file for transmission has a characteristic part (a variable part) indicating that the new file is subjected to file-sending. That is, each new file for transmission having a file name which varies with send is sent to the server. Therefore, it is possible to prevent overwriting resulting from that files having the same name are sent to the server. The number of transmissions is counted by the general controlling section 211, and stored in a ROM (for example EEPROM) within a general controlling section 601.

Furthermore, since the variable part has a number part updatd for each file-sending operation, even when files which are similar to each other exist in the server, it is possible to readily recognize whether these files are transmitted at the same point of time or at different points of time.

Furthermore, since the variable part has a number which increases in accordance with the number of times of send (in other words, a number which increases in response to file-transmission history), it is possible to readily recognize that which file was sent later than the other files. That is, it is possible to readily recognize the before-and-after relationship in file sending. While a number incremented by one in accordance with the number of times of send is applied to the variable part in the above description, a number incremented by two may be applied to the variable part, or a number incremented by other values may be applied to the variable part, without being limited to the above number incremented by one.

Though the above description was made while exemplifying the case where a number which increases in accordance with the number of times of send is applied into the file name as the variable part, a random number may be applied for each operation without being limited to the this. In such a case, however, it is preferred that the number that has been used should be eliminated so as to prevent overlapping of the number.

Furthermore, a file name of “new file for transmission” has a part common to a file name of “original file for transmission” (in other words, invariable part). To be more specific, the part including an image number consisting of five digits and a file type identifier consisting of three characters corresponds to the common part (invariable part). Since this common part is invariable before and after changing the file name, it is possible to readily recognize the correspondence between the correlation between the file remaining in the digital camera (original file for transmission) and the file that has been sent to the server (new file for transmission).

Furthermore, in the case where a plurality of files are designated as the “original file for transmission” in one sending operation, the file names are determined such that variable parts of a plurality of new files for transmission corresponding to the plurality of original files for transmission are common. To be more specific, the file names having the same send number in their variable parts can be adopted. For example, as shown in FIG. 17, in the case where data contents of three original files for transmission named “PIC00456.JPG”, “PIC00345.JPG” and “PIC12345.JPG” are sent in the total of 78th sending operation, the three new files for transmission that have been generated by copying these three original files for transmissions can be named “07800456.JPG”, “07800345.JPG” and “07812345.JPG”, respectively. In such a case, there is the common part “078” in the first parts of these three new files for transmission. Therefore, in the case where a plurality files are sent at once, it is possible to readily recognize that these are the files that have been sent at the same point of time.

Furthermore, an original file for transmission is a photographed image file by the digital camera, and the file name of the photographed image file is automatically given by the digital camera 1 at the time of photographing in accordance with a predetermined rule, so that it is not necessary for the operator to intentionally (definitely) give its file name from photographing of image to transmission. That is, basically, since photographing of image and sending operation can be achieved without requesting the operator to give a file name, an excellent operability is realized. Particularly, in the digital camera 1, since it is difficult to provide an input measure such as keyboard having high general versatility, the operability can be significantly improved by eliminating the necessity of inputting a file name.

Furthermore, on the server side, there is a case that the number of characters used for a file name is restricted. For example, some servers provide a restriction that a file name should be given by eight or less characters (excluding a file identifier of three characters). Even under such a restriction, by conducting sending in the manner as described above which is associated with changing of file name, it is possible to prevent overwriting of file in the server.

<B. Second Preferred Embodiment>

In this second preferred embodiment, an explanation is made for the case where overwriting of file is prevented by changing a folder of the file transmission destination for each sending operation.

A data communication terminal according to the second preferred embodiment has a configuration similar to that of the first preferred embodiment. In the following, explanation will made while putting the accent on different points therebetween.

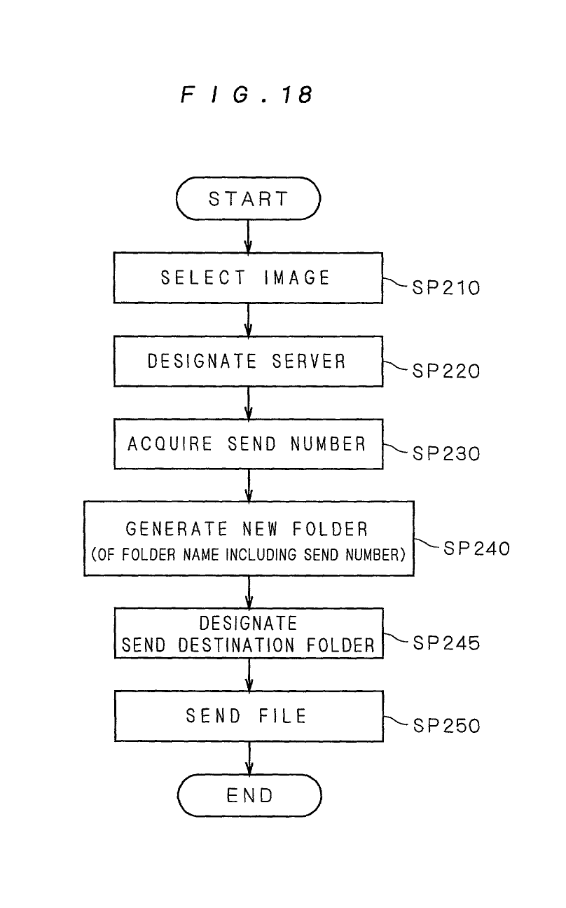

FIG. 18 is a flowchart showing a procedure of data sending in the second preferred embodiment. As shown in FIG. 18, as for steps SP210, SP220 and SP230, operations similar to those in steps SP10, SP120 and SP 130 of the first preferred embodiment (FIG. 4) are carried out.

After that, in step SP240, a command for a server to generate a new folder in the server is issued from the digital camera to the server. At this time, a folder name is generated for each file-sending operation to the server, and different folder names are given for the respective new folders. To be more specific, as the folder name, those having numbers which increase in accordance with the number of times of send can be adopted. In other words, as the folder name, those having numbers increasing in response to a counting number of file-sending operation from the digital camera can be adopted. For example, a number of times of send (or send number) can itself be adopted as the folder name.

Then, in step SP245, a new folder created in the server for that sending operation is designated as a destination folder, and in step SP250, the new file for transmission is sent to the server. In this case, individual files that have been sent in different sending operations are separately stored in different folders. Therefore, overwriting with regard to files of the same name can be prevented. In this case, unlike the aforementioned preferred embodiment, it is not necessary to change the file name itself, and the same file name as the file name at the time of photographing can be used as the file name of “new file for transmission”.

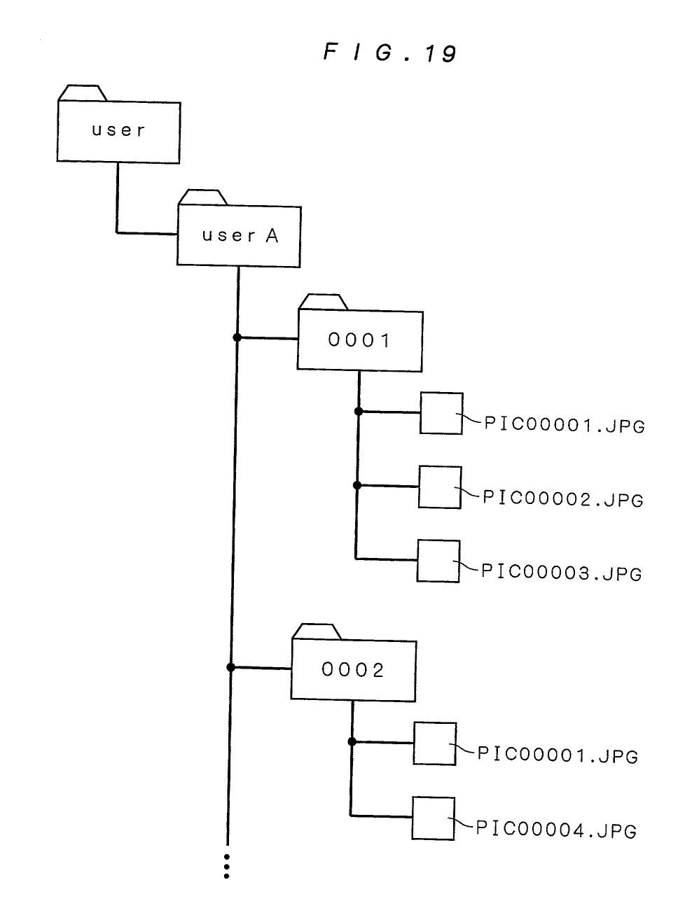

FIG. 19 is a view showing a folder tree (or file tree) of a transmission destination server. As is apparent from this drawing, in a “user” folder that is assigned to users in a memory area of the server, a folder of an individual user “user A” who is the operator of this digital camera is provided. An image file sent from the digital camera is stored in this individual user's folder “user A”. Until this step, the same as described in the first preferred embodiment applies.

However, the second preferred embodiment differs from the first preferred embodiment in that a new folder is sequentially created for every sending operation in this folder “user A”.

To be more specific, three files “PIC00001.JPG”, “PIC00002.JPG” and “PIC00003.JPG” that are sent in the first sending operation are stored in the folder “0001”. Likewise, two files “PIC00001.JPG” and “PIC00004.JPG” that are sent in the second sending operation are stored in the folder “0002”. In such a case, though the files “PIC00001.JPG” are sent in both of the first and the second sending operations, these files can be distinguished from each other because they are stored in different folders. Therefore, it is possible to prevent overwriting.

In the above description, a folder name of new folder is created using only a number of times of send, however, the name may be created while combining at least part of a serial number of the digital camera 1 and a number of times of send without being limited to the above. For example, a folder name may be created by combining a 4-digit number of times of send with a last 4-digit of serial number.

<Third Preferred Embodiment>

In the third preferred embodiment, explanation will be made on the art in which a list of file names in a transmission destination server is acquired; whether a preceding file having the same name as a data file to be sent exists is determined with respect to files provided with file names having a predetermined identification mark (identifier) among files contained in the list; and a warning is made when the preceding file is found in the list.

Also the digital camera according to the third preferred embodiment has a similar configuration as that of the digital camera according to the first preferred embodiment, and different points therebetween will be mainly described below. Also in this third preferred embodiment, as is in the second preferred embodiment, as a file name of “new file for transmission”, a file name as same as the file name at the time of photographing (therefore, a file name as same as a file name of “original file for transmission”) is used in principle.

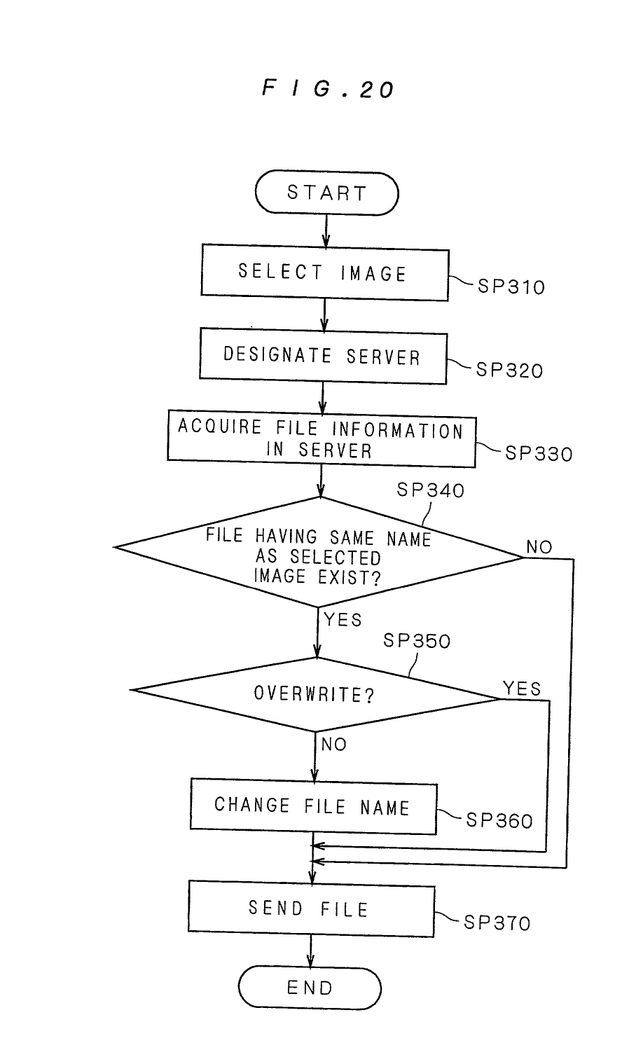

FIG. 20 is a flowchart showing a procedure of data transmission in the third preferred embodiment.

As shown in FIG. 20, first in step SP310, in the same manner as described above, an image to be sent is selected, and in step SP320, a transmission destination server is designated.

Then, in step SP330, the digital camera issues an instruction for the transmission destination server to send back file list information in a send destination folder of the transmission destination server, and acquires the file list information (hereinafter, simply referred to as “file list”) by receiving the reply.

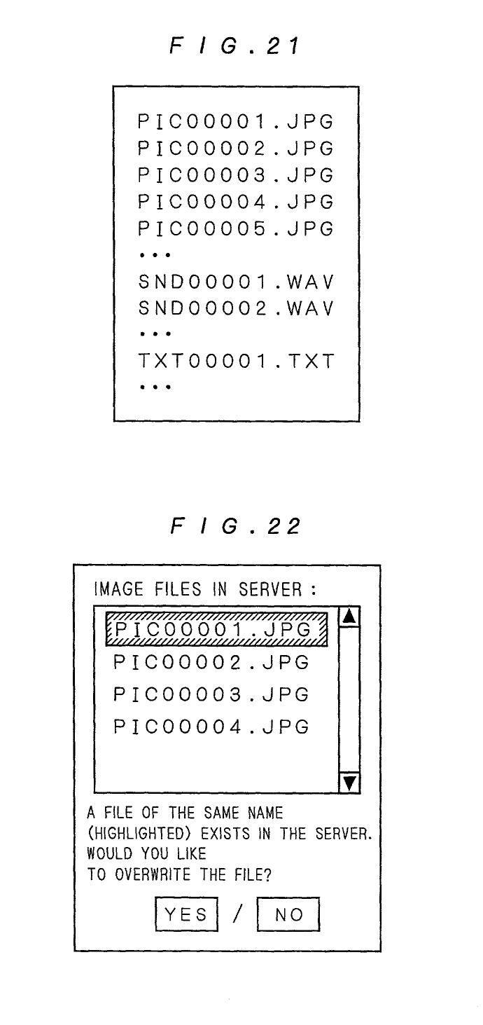

FIG. 21 is a view showing one example of an acquired file list. As shown in FIG. 21, in the send destination folder, not only image files such as “PIC00001.JPG”, “PIC00002.JPG” and “PIC00003.JPG”, but also a variety types of files including sound data files “SND00001.WAV” and “SND00002.WAV” and document files such as “TXT00001.TXT” exist.

In this description, a searching operation for checking whether the same file already exists in the server is carried out for image files which are images photographed by the digital camera among the above plurality of files. In this situation, a file name of data sent from the digital camera 1 is given with “PIC” at its head. Furthermore, as an identifier indicative of image data, “JPG” is given at the last part subsequent to the period.

Next, in step SP340 (FIG. 20), it is determined whether a file having the same name as the image file selected as an object to be sent exists in the file list, or in other words, whether a file having the same name as the file to be sent exists in the file list.

File to be searched in this determination are such files that have file names including “PIC” at its head and “JPG” at its last part. In the manner as described above, whether or not a file having the same name as the file to be sent exists is determined by carrying out a search with respect to the files having a predetermined identification mark (such as “PIC” and “JPG”) in their file names. Therefore, it is possible to determine whether or not a file having the same name as that of the file to be sent exists with higher efficiency compared to the case where a search is carried out with respect all of the files in a send destination folder of the transmission destination server.

If a file having the same name as that of the file to be sent does not exist, the flow proceeds to step SP370 where the file is sent in the current name.

On the other hand, if a file having the same name as that of the file to be sent exists, the flow proceeds to step SP350. In step SP350, the digital camera 1 inquires of the operator whether or not the operator approves overwriting of the file. In other words, the digital camera 1 warns that a file having the same name as that of the file to be sent exists and accepts an instruction from the operator as to whether or not he/she approves overwriting of the file. To be more specific, as shown in FIG. 22, it is possible to inquire of the operator, for example, by displaying the warning “A file of the same name exists in the transmission destination server. Overwrite the file ?” in the LCD 10 and the like of the digital camera 1, or by producing a voice output in the form of a synthetic voice of the above warning. In response to this, the operator can give an instruction as to whether he/she approves overwriting of the file to the digital camera 1 by making a predetermined operation.

At this time, as shown in FIG. 22, the existence of the file having the same name as that of the file to be sent can be more clearly displayed in relation to other files, if the existence of the file having the same name as that of the file to be sent is displayed in reverse video while displaying information representation of files (or a list of files) having a predetermined identification mark (such as “PIC”) indicative of an image photographed by the digital camera 1. In particular, a display section of a digital camera has a relatively small area in comparison with a monitor screen of general computers, and hence by limiting the object to be displayed in a file list to similar files having the same identification mark (such as “PIC”), it is possible to display necessary information in a narrow display area of an LCD and the like in the digital camera.

Then, in the case where an instruction that the operator approves overwriting of the file is given by the operator, and the digital camera 1 accepts the indication (in the case where overwriting is to be made), the digital camera 1 sends the file without changing the file name (Step SP370).

Contrarily, in the case where an instruction that the operator does not approve overwriting of the file is given by the operator (in the case where overwriting is not to be made), the flow proceeds to step SP360 where the file name is changed. The file name is changed to an arbitrary file name designated by the operator. At this time, as shown in FIG. 22, if a list of acquired files is displayed on the LCD 10 for the operator, it becomes easy for the operator to give a different file name in determining the file name. Thereafter, the flow proceeds to step SP370 where the file of which file name has been changed is transmitted to the server.

In the above description, a file list including information of all files is acquired in step SP330, however, list information regarding only the files that have file names including “PIC” at their heads and “JPG” at their ends may be acquired without limited to the above. In such a case, it is possible to obtain the effect of reducing a transmission time of a file list from the server to the data communication terminal in step SP30, as well as to carry out the searching operation in the following step 340 more efficiently.

<D. Fourth Preferred Embodiment>

This fourth preferred embodiment is a modified example of the third preferred embodiment.

This fourth preferred embodiment explains the art in which a list of file names in the transmission destination server is acquired; a determination as to whether or not a file having the same name as that of the data file to be sent exists is made with respect to the files having file names including a predetermined identification mark among the files included in the list; and if it is determined that a file having the same name as that of the file to be sent exists, the data file to be sent is transmitted to the server after automatically renaming the data file. In the following, the points different from the third preferred embodiment will be mainly described.

FIG. 23 is a flowchart showing a procedure of data transmission in the fourth preferred embodiment.

Steps SP410, SP420 and SP430 are the same operations as steps SP310, SP320 and SP330 in the third preferred embodiment, respectively.

Next, in step SP440, whether or not a file having the same name as that of the image file selected as an object to be sent exists, that is whether or not a file having the same name as that of the file to be sent exists is determined. This step SP440 is the same operation as Step SP340.

As to the subsequent operations, while the third preferred embodiment makes inquiry to the operator, the fourth preferred embodiment does not make inquiry in principle, but automatically changes the file name in accordance with a predetermined rule when it is determined that a file having the same name as that of the file to be sent exists in the server.

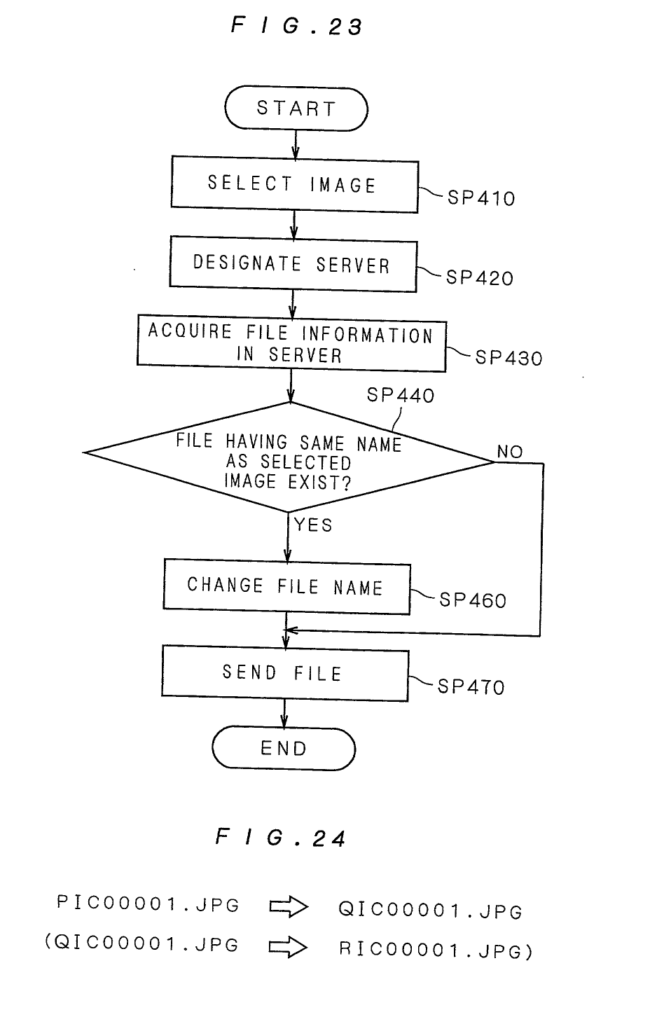

That is, in the case where a file having the same name as that of the file to be sent does not exist, the flow proceeds to step SP470 where the file is transmitted in the current name, while on the other hand, in the case where a file having the same name as that of the file to be sent already exists in the server, the flow proceeds to step SP 460 where the file name is changed. As a file name after changing of the name, those automatically created by the digital camera in accordance with a predetermined rule are used. To be more specific, as shown in FIG. 24, a rule that changes the first character “P” to the next letter in alphabet “Q” can be used. For example, provided that the file name before changing is “PIC00001.JPG”, then the file name after changing is “QIC00001.JPG”. If also the file name “QIC00001.JPG” already exists in the server, the file name after changing can be “RIC00001.JPG”. Thereafter, the flow proceeds to step SP470 where the file of which file name has been changed is sent to the server.

In the above description, while the explanation was made while exemplifying the case where the file name is automatically changed in accordance with the rule that sequentially changes the first character of file name to the next letter in alphabet in step SP460, it is also possible to configure so that a request is made to the operator to indicate the file name after changing, after all letters in alphabet have been used, in the same manner as the third preferred embodiment.

<E. Others>

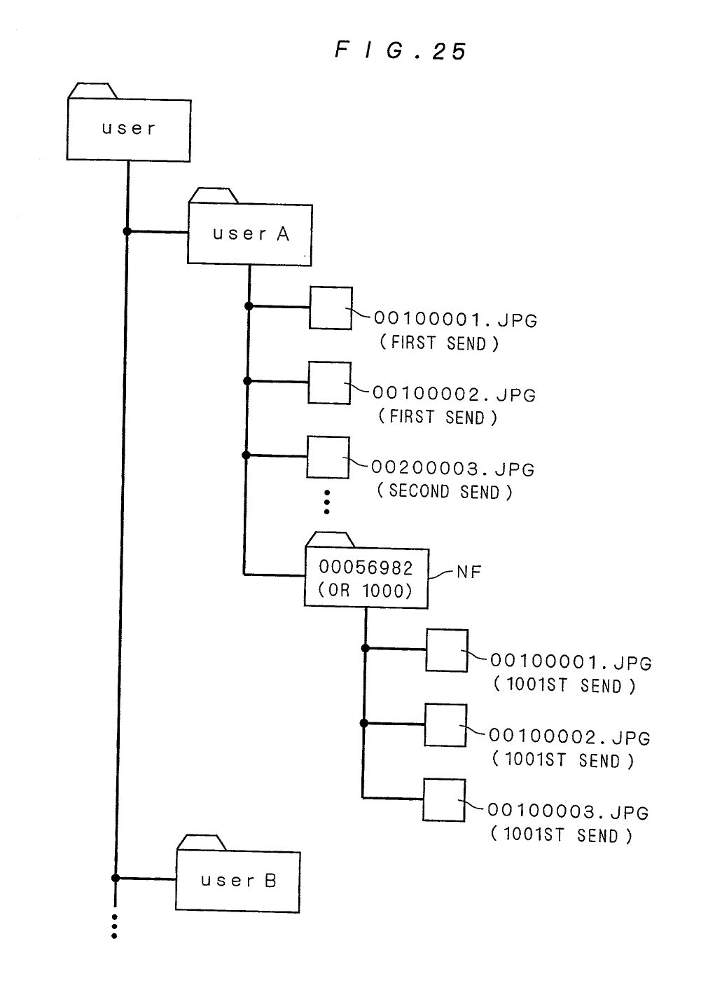

In the first preferred embodiment, a file whose file name has been changed so as to include a number of times of send (send number) of 3-digit is transmitted. Therefore, the transmitted files that have been transmitted up to the 999th sending operation can be recognized as different files, however, there arises a situation that these files cannot be recognized as different files if the number of times of send exceeds 1000. For avoiding this situation, as shown in FIG. 25, for example, in the case where the number of times of send exceeds 1000, a new folder NF is created in the folder “user A” assigned to that user, and the file transmitted in the 1001st sending operation can be transmitted into that new folder NF. In such a case, the name of this transmitted file is “00100001.JPG” which is the same name as that of the file transmitted in the first sending operation, however, since the file transmitted in the 1001st sending operation is created in the new folder NF, it is possible to prevent the file sent in the first sending operation from being overwritten.

As a name of this new folder NF, a folder name “1000” indicative of the one thousands or a folder name (for example, “00056982”) using the last 8-digits of the serial number of the digital camera can be used.

Furthermore, though a digital camera was exemplified as the data communication terminal in the above preferred embodiments, the present invention is not limited to this. For example, the data communication terminal may be a mobile phone, or may be a PDA (personal digital assistant) which manages information of individuals.

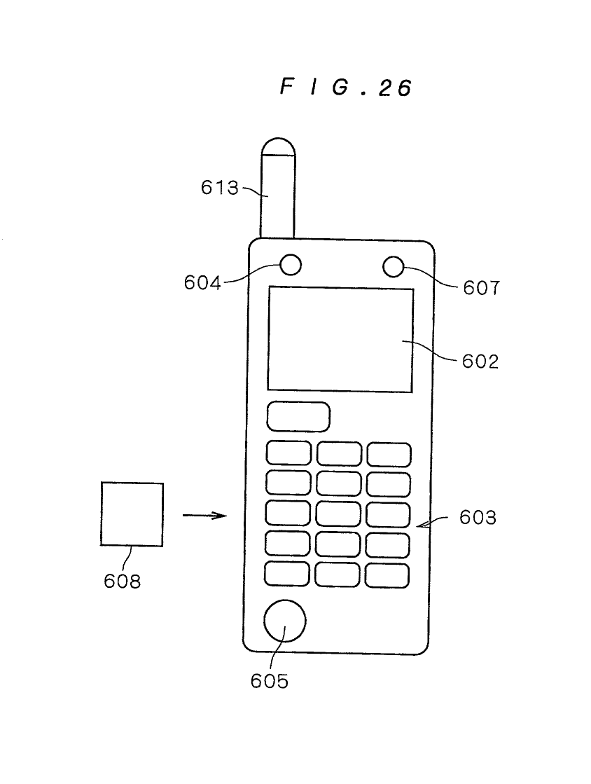

FIG. 26 is a view showing a mobile phone 1E functioning as a data communication terminal. The mobile phone 1E also has a function of PDA.

The mobile phone 1E comprises a display section 602 including an LCD and the like, a operational section 603 including numerical keys and the like, a voice output section 604 including a speaker and the like, a voice input section 605 including a microphone and the like, and an antenna 613 for radio communication. Also, the mobile phone 1E further comprises a photographing section 607 so that it can photograph an image (a still image, for example). Also it has a function of transmitting the photographed image to a server over telephone circuit. That is, the mobile phone 1E has a file (image file) transmitting function in addition to the usual vice communication function.

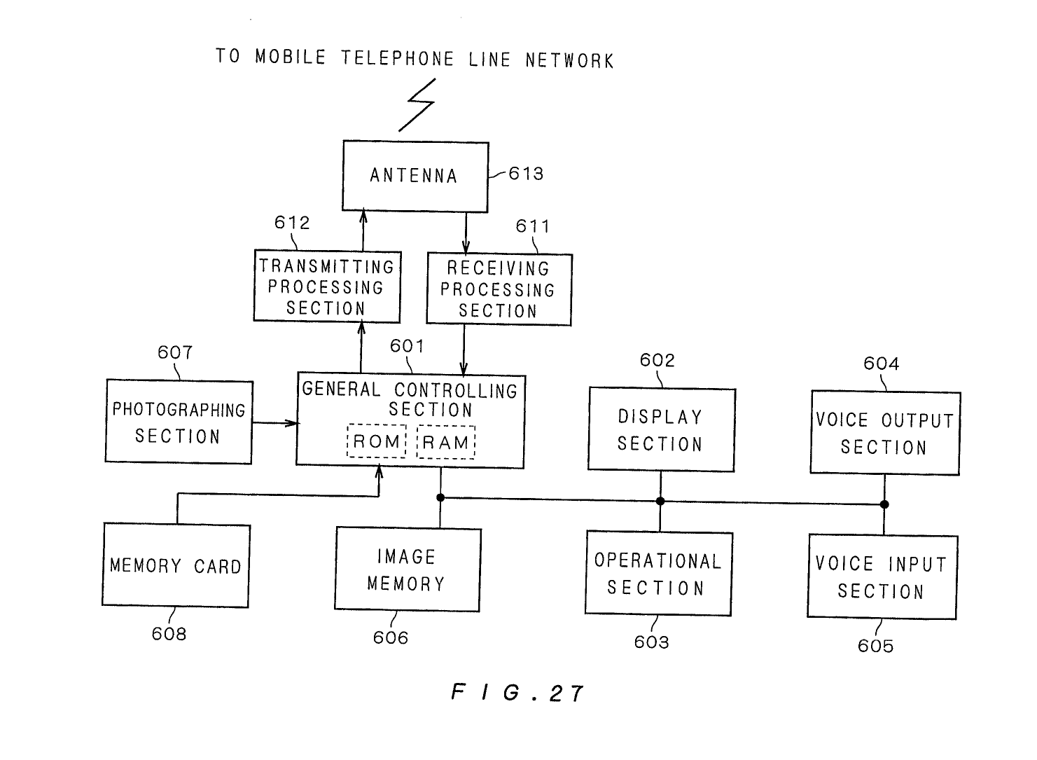

FIG. 27 is a functional block diagram of the mobile phone 1E. As shown in FIG. 27, the mobile phone 1E comprises the general controlling section 601, the display section 602, the operational section 603, the voice output section 604, the voice input section 605, an image memory 606, the image photographing section 607, a memory card 608, a reception processing section 611, a transmission processing section 612 and the antenna 613. The mobile phone 1E having such a configuration can forward images stored in the memory card 608 or images photographed by the image photographing section 607 to the image memory 606 and transmit the forwarded images to a predetermined server via network of mobile phone circuit using the transmission processing section 612, the antenna 613 and the like. Each operation is carried out under the control of the general controlling section 601. The general controlling section 601 can count the number of times of file transmission and stores it in a ROM (for example, EEPROM) and the like in the general controlling section 601.

The present invention is also applicable to the mobile phone 1E as described above, and owing to the present invention, it is possible to avoid overwriting of file by mistake.

Furthermore, in the above description, the explanation was made for the case where an image file is transmitted, however, other types of files may be transmitted without being limited to this. For example, the present invention is applicable also to the case where an address book file in which addresses and telephone numbers of individuals are recorded is transmitted.

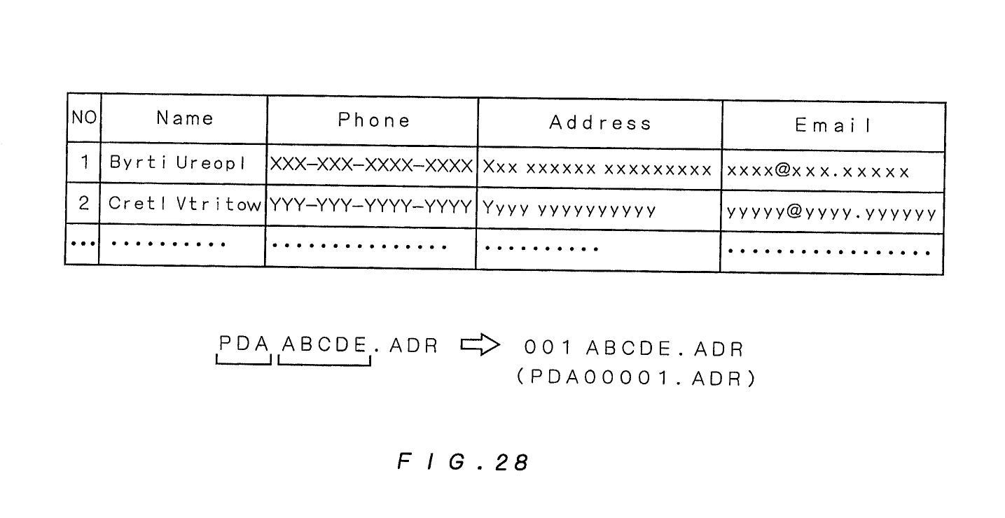

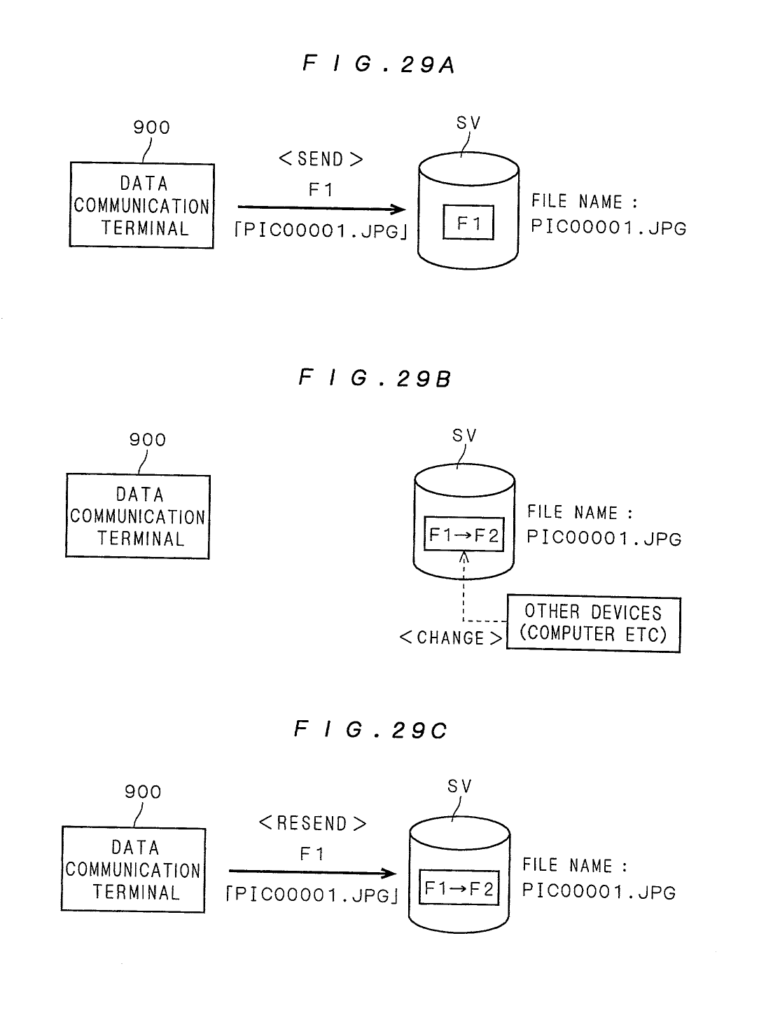

FIG. 28 is a view showing the file contents of a file name “PDAABCDE.ADR”. This file is an address book file which manages information regarding a plurality of individuals, and more specifically, a file including various information including a name (Name), a telephone number (Phone), an address (Address) and an electronic mail address (Email) of an individual.

Also for transmitting this file name, the sending operation as same as that described above can be carried out. For example, likewise the first preferred embodiment, in sending an original file for transmission having a file name “PDAABCDE.ADR”, the file name of a new file for transmission in the first transmission can be “001ABCDE.ADR” and the file name of a new file for transmission in the second transmission can be “002ABCDE.ADR”.

Alternatively, in sending an original file for transmission having a file name of “PCAABCDE.ADR”, it is also possible to make the head part of the file name invariable and the remaining part variable. For example, a file name of a new file for transmission can be determined so that in the file name of the original file for transmission, the first three characters “PDA” are invariable, and the following five characters are the number that increase with the number of times of send. To be more specific, with respect to the file name of the original file for transmission “PDAABCDE.ADE”, the file name of the new file for transmission can be determined as “PDA00001.ADR”. In this case, though the part regarding “ABCDE” is deleted from the file name, the file can be identified from the combination of “PDA” which identifies an address book file transmitted by a mobile phone and the send number “00001” from that mobile phone.

While the invention has been shown and described in detail, the foregoing description is in all aspects illustrative and not restrictive. It is therefore understood that numerous other modifications and variations can be devised without departing from the scope of the invention.

What is claimed is:

1. A data communication terminal which sends data to a server, comprising:
a designating part for designating an original file having an original file name and data contents;
a file name giving part for generating a new file obtained by copying said data contents of said original file and giving a new file name which is different from said original file name; and
a sending part for sending said new file to said server,
wherein the new file name has a characteristic part indicating that said new file is subjected to file-sending.

2. The data communication terminal according to claim 1,
wherein the new file name has a common part common to said original file name.

3. The data communication terminal according to claim 1, wherein said characteristic part has a number part updated for each file-sending operation.

4. The data communication terminal according to claim 3, wherein said number part has a umber increasing in response to file-transmission history.

5. The data communication terminal according to claim 4, wherein a plurality of original files are allowed to be designated for a single file-sending operation, and
said characteristic part is common among respective new file names generated for a plurality of new files corresponding to said plurality of original files.

6. The data communication terminal according to claim 1,
wherein said data communication terminal is a camera.

7. The data communication terminal according to claim 6,
wherein said original file is a photographed image file, and
said original file name is given in accordance with a predetermined rule at the time of image photographing.

8. A data communication terminal which sends data to a server, comprising:
a command issuing part for issuing a command to create a new folder in said server for each file-sending operation before sending a data file to said server; and
a sending part for sending said data file into said new folder created in said server in accordance with said command.

9. The data communication terminal according to claim 8,
wherein a file name of said new folder has a number increasing in response to a counting number of file-sending operation from said data communication terminal.

10. A camera capable of sending data to a server, comprising:
a designating part for designating a data file;
an acquiring part for acquiring a file list representative of files stored in a predetermined folder of said server;
a determination part for determining, with respect to files of file names having a predetermined identifier among files included in said file list, whether or not a preceding file having the same name as that of said data file exists; and
a warning part for giving a warning when said preceding file is found in said file list.

11. The camera according to claim 10, further comprising:
a receiver for receiving an instruction from an operator as to whether the operator approve overwriting when said preceding file is found; and
a sending part for sending said data file to the server when the instruction that overwriting is approved is received by said receiving section.

12. The camera according to claim 10, further comprising:
a display for displaying information representative of files having a predetermined identification mark in respective file names among files included in said file list.

13. A camera capable of sending data to a server, comprising:
a designating part for designating a data file;
an acquiring part for acquiring a file list representative of files stored in a predetermined folder of said server;
a determination part for determining, with respect to files of file names having a predetermined identifier among files included in said file list, whether or not a preceding file having the same name as that of said data file exists; and
a sending part for sending said data file to the server after renaming said data file when said preceding file is found in said file list.

14. A computer program capable of being installed in a microcomputer included in a communication terminal, wherein execution of said computer program by said microcomputer generates a software control structure in said communication terminal for sending data to a server through a network, said control structure comprising:
a designating part for designating an original file having an original file name and data contents;
a file name giving part for generating a new file obtained by copying said data contents of said original file and giving a new file name which is different from said original file name; and
a sending part for sending said new file to said server,
wherein the new file name has a characteristic part indicating that said new file is subjected to file-sending.

15. A computer program capable of being installed in a microcomputer included in a communication terminal, wherein execution of said computer program by said microcomputer generates a software control structure in said communication terminal for sending data to a server through a network, said control structure comprising:
a command issuing part for issuing a command to create a new folder in said server for each file-sending operation before sending a data file to said server; and
a sending part for sending said data file into said new folder created in said server in accordance with said command.

16. A computer program capable of being installed in a microcomputer included in a camera, wherein execution of said computer program by said microcomputer generates a software control structure in said camera for sending data to a server through a network, said control structure comprising:
a designating part for designating a data file;
an acquiring part for acquiring a file list representative of files stored in a predetermined folder of said server;
a determination part for determining, with respect to files of file names having a predetermined identifier among files included in said file list, whether or not a preceding file having the same name as that of said data file exists; and
a warning part for giving a warning when said preceding file is found in said file list.

17. A computer program capable of being installed in a microcomputer included in a camera, wherein execution of said computer program by said microcomputer generates a software control structure in said camera for sending data to a server through a network, said control structure comprising:
a designating part for designating a data file;
an acquiring part for acquiring a file list representative of files stored in a predetermined folder of said server;
a determination part for determining, with respect to files of file names having a predetermined identifier among files included in said file list, whether or not a preceding file having the same name as that of said data file exists; and
a sending part for sending said data file to the server after renaming said data file when said preceding file is found in said file list.
